(19) United States
(12) Patent Application Publication
(10) Pub. No.: US 2010/0269649 A1
(43) Pub. Date: Oct. 28, 2010

(54) Power Threading and Cutting Device with Sliding Support

(76) Inventor: Gordon Rantz, Plainwell, MI (US)

Correspondence Address: JANSSON SHUPE & MUNGER LTD., 245 MAIN STREET, RACINE, WI, 53403, US

(21) Appl. No.: 12/768,504

(22) Filed: Apr. 27, 2010

Related U.S. Application Data
(60) Provisional application No. 61/173,576, filed on Apr. 28, 2009.

(51) Int. Cl. B23G 1/52; B23G 1/24; F16M 11/04

(52) U.S. Cl. 82/113; 248/124.2

(57) ABSTRACT

An adjustable support for supporting power threading and cutting devices is provided. The support includes an elevated stand adapted for holding a work piece, a support member and an adjustable bracket mounted to the elevated stand. The adjustable bracket is configured to receive the support member whereby the support member is free to move longitudinally and laterally with respect to the work piece so that the support member can be positioned either distal or proximal to a front end of the elevated stand. The support arm may be a support arm which is secured to the elevated stand and slidably received along an axis parallel to the work piece. A power threading and cutting device having a powered element to engage a work piece and a support adjustable in at least two axes parallel to the work piece is also contemplated. The adjustable support may be conveniently moved out of the operational area when it is not in use.

### RELATED APPLICATION

This application is based on U.S. Provisional Application 61/173,576, filed on Apr. 28, 2009.

### FIELD OF THE INVENTION

The invention pertains to pipe threading and the related tools and methods and particularly, portable powered threading and cutting devices used in conjunction with a portable vise. More particularly, positionable support arms for use with threading and cutting devices for threading or cutting work pieces including 1″ and larger diameter pipes.

### BACKGROUND OF THE INVENTION

The task of threading and cutting work pieces including pipe larger than 1″ in diameter with a portable power drive exposes the user to risk of bodily harm. When a user attempts to thread large work piece or large diameter pipe with a portable power drive and a pipe vise with no additional tools, the torque generated is difficult to manage. If the power drive gets away from the user, the rotational acceleration of the tool generates momentum that could easily injure and possibly fatally injure the user, damage the surrounding work environment or damage one or more of the tools being used. Even if the user is successful in setting up a threading and or cutting arrangement (as discussed below), managing such a large force, particularly throughout the course of a long workday, can represent challenging work conditions, which can lead to long-term, work-related injuries.

Many users of portable power drives in conjunction with pipe vise systems have found it desirable to transfer the reactionary torque developed in the power drives to the pipe vise stands, particularly when processing pipe which is 1″ and larger. However such use is not without added parasitic force, misdirected force, sloppiness in the trade, danger to the operator, and increased time to satisfactorily complete the threading operation. Such previous systems to transfer reactionary torque include the user wrapping a single piece of chain around the handle of the power drive and the leg of the vise stand. Such a chain loosely constrains the motion, thus controlling the reactionary torque in the portable power drive while the user is threading or cutting a work piece, particularly large-diameter pipes. Is remains difficult to control the forces, directions and angles of operation so that components of the power drive-pipe vise system do not excessively wear or prematurely wear out. It is also difficult for the user to achieve proper positioning to operate the power drive and the proper posture and stance while conducting the threading and cutting operation

The common method of chaining the handle of the portable power drive to the leg of the tripod also presents possible dangers to the user or the tools involved. If the chain disengages, falls off the handle, or in any way stops attaching the handle to the leg, the power drive is again free to rotate, possibly causing harm to the user or to the tools involved.

Furthermore, in chaining the handle of the power drive to the tripod, the user is again subjected to a poor ergonomic stance because the handle of the power drive (and the actuation switch) is located near the floor. Relatively large and/or strong users may be successful in managing the large torque in the frame of the power drive, however they are also burdened with the task of holding the tripod vise to the floor. Since the generated torque is rather large, the tripod stand has a tendency to swing out or pivot from underneath the work. This represents a particularly dangerous situation since the user is still holding onto the momentary power switch of the power drive. The tripod then quickly generates angular momentum of sufficient force to not only damage the tools, but also to injure the user or others in the area.

Construction sites require workers to perform repetitive tedious processes which lend to effecting shortcuts and quicker methods of operation. These shortcuts and modified methods introduce dangers and risks previously discussed. Threading and cutting work pieces—especially those of large-diameter pipe—is an arduous and time-consuming task. Currently-available technology provides less desirable methods of torque absorption at the expense of significant exposure to the user and significant additional time in carrying out the threading and cutting operation. When time is of the essence, as it is on any construction site, safety and speed are of the utmost importance.

Accordingly, it would be desirable to provide a power threading and cutting device having a movable arm to position the power drive, provide ample work space clearance, provide safe operation in all work environments, and absorb the reactionary torque produced when threading or cutting a work piece of any size, and particularly pipe between 1″ and 2″ in diameter.

It would also be desirable to provide a power threading and cutting device which supports the weight of the power drive when threading any size work piece including any diameter pipe.

It would be desirable to provide a power threading and cutting device which saves time and provides safe one handed threading and cutting of a work piece including pipe of any diameter, and particularly pipe of 1 inch diameter and larger, while allowing the user to perform additional functions with their free hand as a result of the one-handed operation.

It would be desirable provide a power threading and cutting device which is simple in operation, safe to use, inexpensive to manufacture and adaptable to accommodate the majority of currently-available brands and variations of power threading and cutting tools.

### SUMMARY OF THE INVENTION

The power threading and cutting device of the present invention provides improved convenience such that users will prefer to use the invention, even when threading or cutting small work pieces such as small diameter pipe (pipe less than 1″ in diameter). The device of the present invention only requires one hand to use. Normally, a user would use two hands just to manage the torque and weight of the power drive. This is a problem because properly threading pipe requires lubricating the work with oil while cutting work pieces including cutting threads. One-handed operation allows the user to use their free hand to oil the work piece while it is being cut or threaded. Any additional time experienced with the free hand can also be used to clean up debris, organize tools, prepare for the next operation, or any other task that increases a user's productivity. The current invention allows not only a greatly-improved method, but also substantially improved operational speed.

An adjustable support for supporting power threading and cutting devices is provided. In a preferred embodiment, the support includes an elevated stand adapted for holding a work piece, a support member and an adjustable bracket mounted to the elevated stand. The adjustable bracket is configured to receive the support member whereby the support member is free to move longitudinally and laterally with respect to the work piece so that the support member can be positioned either distal or proximal to a front end of the elevated stand. The support arm may be a support arm which is secured to the elevated stand and slidably received along an axis parallel to the work piece. Another preferred embodiment includes a power threading and cutting device having a powered element to engage a work piece and a support adjustable in at least two axes parallel to the work piece is also contemplated. The adjustable support may be conveniently moved out of the way when it is not being used.

In yet another preferred embodiment of the adjustable support for power threading and cutting devices of the present invention a stand adapted for holding a work piece, a support member, and an adjustable bracket mounted to the stand are provided. The adjustable bracket is configured to receive the support member and the support member is free to move longitudinally and laterally with respect to the work piece so that the support member can be positioned either distal or proximal to a front end of the stand. Another preferred embodiment includes an adjustable support being a support arm which is secured to the elevated stand. The support arm may be slidably received along an axis parallel to the work piece.

In another preferred embodiment, the support arm is slidably received along at least two axes parallel to the work piece. Another preferred embodiment provides an adjustable support for power threading and cutting devices including a vise attached to the elevated stand having a receiving cradle for receiving the work piece which may include a pipe including the support arm being slidably received along an axis parallel to the pipe.

In yet another preferred embodiment of the adjustable support for power threading and cutting devices, the receiving cradle includes a tray having a length which is dimensioned for receiving and holding the pipe. The receiving member may be a hollow frame member positioned outward from the elevated stand. In another preferred embodiment, the support arm may be slidably received by the frame member fastened to the tray and the support arm may be free to move longitudinally and laterally with respect to the work piece while the work piece is held in position upon the tray.

In a further preferred embodiment a power threading and cutting device includes a powered element to engage a pipe, an elevated stand adapted for holding the pipe, a support member and an adjustable bracket mounted to the stand. The support member is configured to receive the support member, and the support member is free to move longitudinally and laterally with respect to the pipe so that the support member can be positioned either distal or proximal to a front end of the elevated stand. In yet another preferred embodiment, the support arm resists the torque forces placed upon the drive when the power threading and cutting device is engaged with the pipe.

Another preferred embodiment includes a machine support apparatus for use with a portable power drive device having an elevated stand for holding a length of pipe, a support member for supporting the portable power drive device and an adjustable bracket mounted to the stand for receiving the support member. The support member and the portable power drive are movable longitudinally and laterally with respect to the pipe so that the portable power drive can be positioned with respect to the front of the stand for engagement with the pipe.

In yet another preferred embodiment, the support arm resists the torque forces placed upon the power drive when the portable power drive is engaged with the pipe and particularly when the portable power drive is engaged with the pipe for threading.

### DESCRIPTION OF THE DRAWINGS

In order that the advantages of the invention will be readily understood, a more detailed description of the invention briefly described above will be rendered by reference to specific embodiments that are illustrated in the appended drawings. Understanding that these drawings depict only typical embodiments of the invention and are not therefore to be considered limiting of its scope, the invention will be described and explained with additional specificity and detail through the use of the accompanying drawings, in which:

FIG. 1 is a top view of one embodiment of a power threading and cutting device in accordance with the present invention;

FIG. 2 a side perspective view of the power threading and cutting device of FIG. 1;

FIG. 3 a front view of the power threading and cutting device illustrated in

FIG. 1;

FIG. 4 a right side view of the power threading and cutting device illustrated in FIG. 1;

FIG. 5 a top view of the support arm of power threading and cutting device illustrated in FIG. 1;

FIG. 6 a side perspective view of the support arm illustrated in FIG. 5;

FIG. 7 a front view of the support arm illustrated in FIG. 5;

FIG. 8 a right side view of the support arm illustrated in FIG. 5;

FIG. 9 an exploded perspective view of the support arm illustrated in FIG. 5;

FIG. 10 is a top view of one embodiment of a power threading and cutting device with the power drive mounted for use;

FIG. 11 a side perspective view of the power threading and cutting device illustrated in FIG. 10;

FIG. 12 a front view of the a power threading and cutting device illustrated in FIG. 10;

FIG. 13 a right side view of the a power threading and cutting device illustrated in FIG. 10;

FIG. 14 is a top view of one embodiment of a power threading and cutting device with the power drive in use;

FIG. 15 a side perspective view of the power threading and cutting device illustrated in FIG. 14;

FIG. 16 a front view of the a power threading and cutting device illustrated in FIG. 14; and

FIG. 17 a right side view of the a power threading and cutting device illustrated in FIG. 14.

### DESCRIPTION OF THE INVENTION

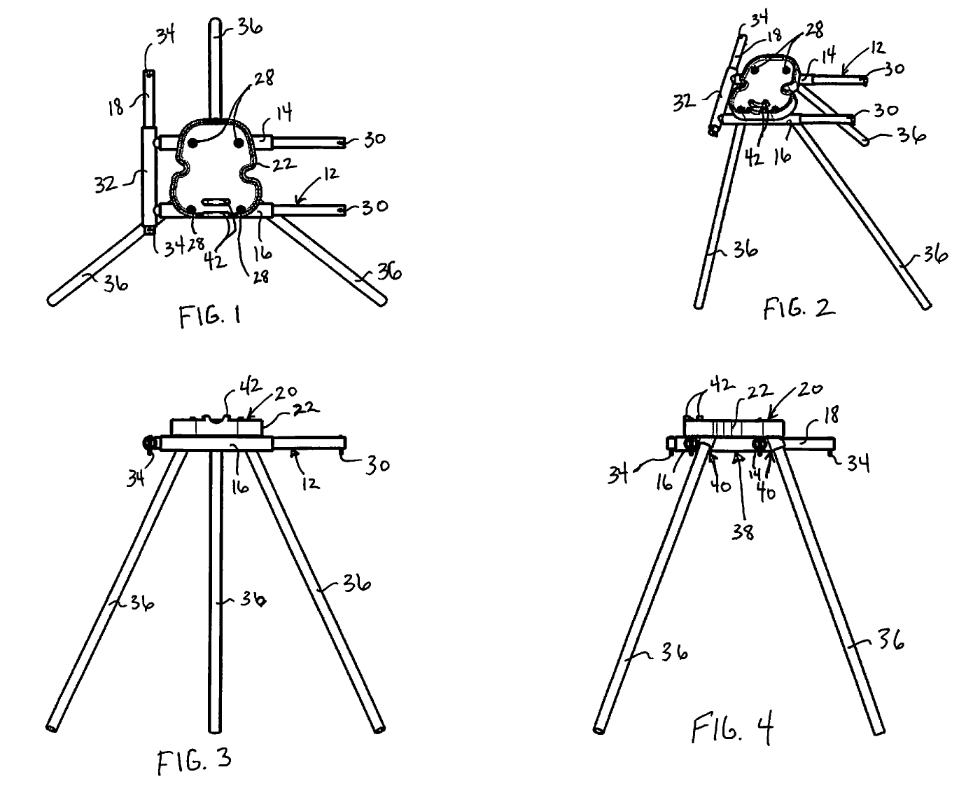

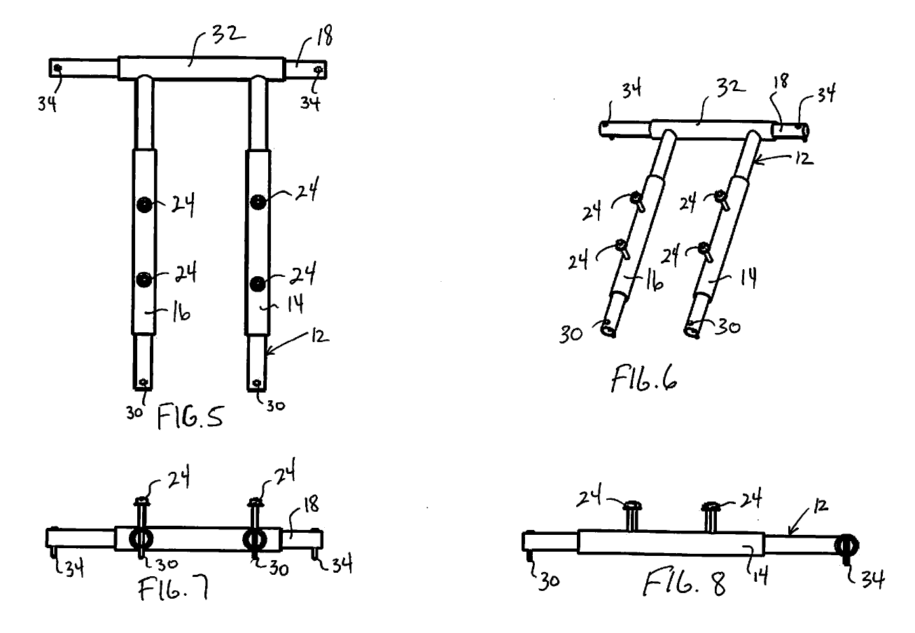

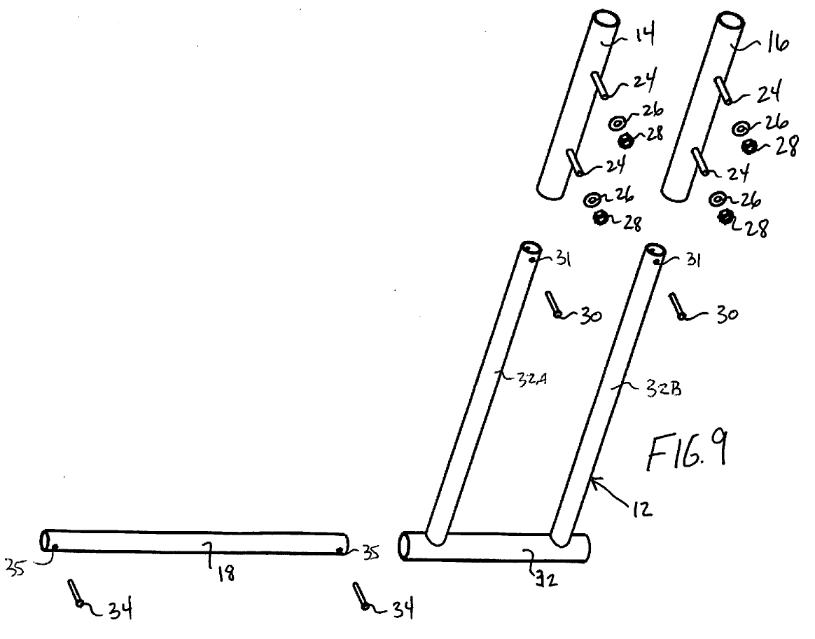

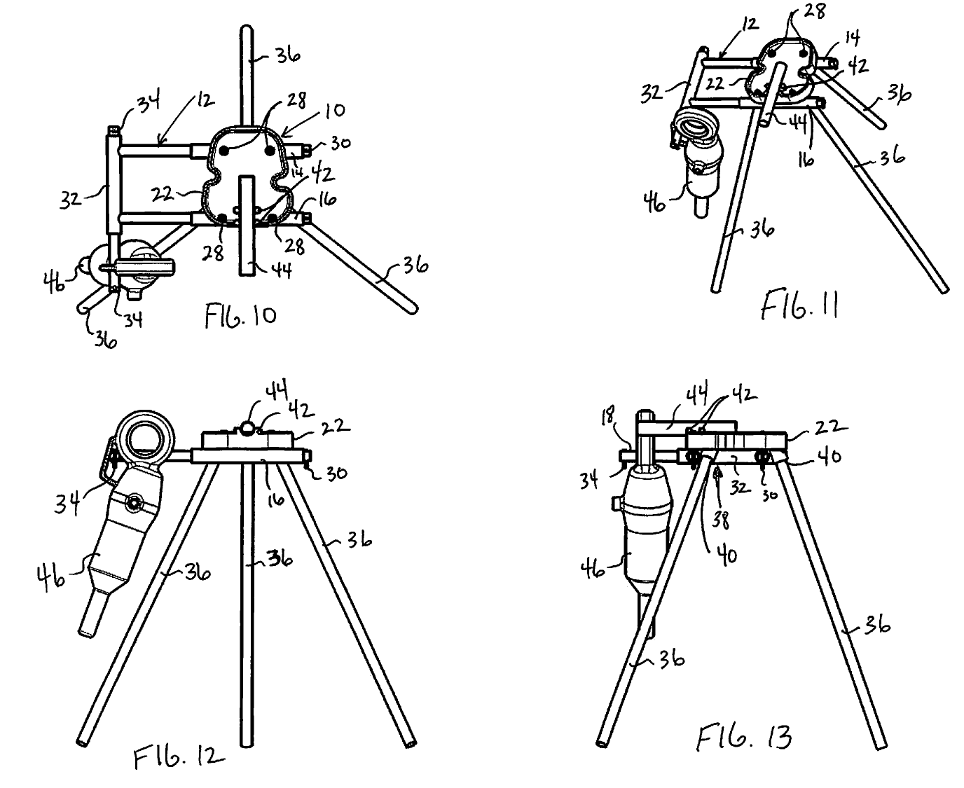

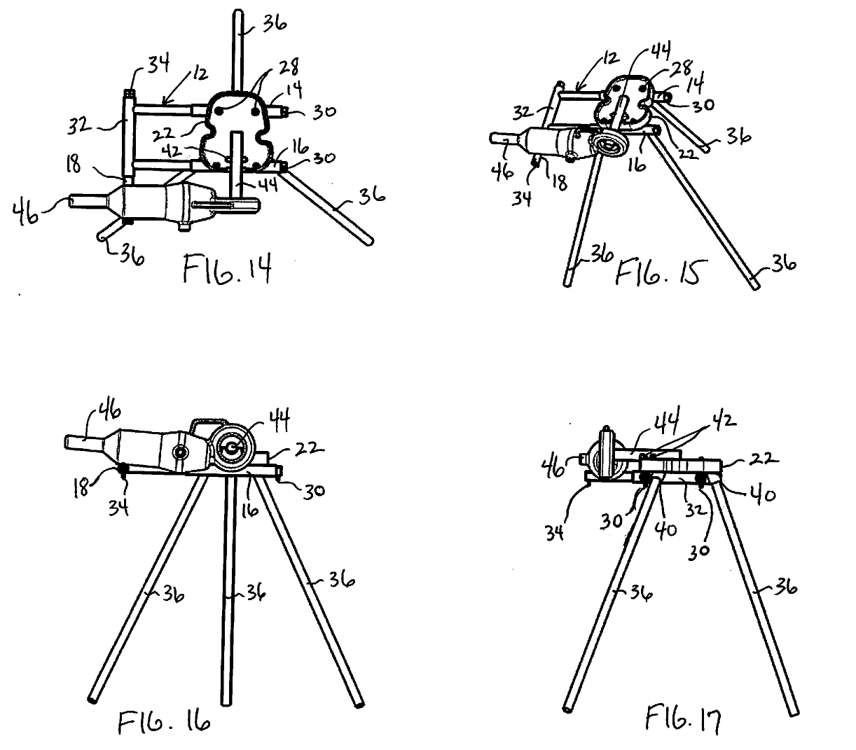

Referring to FIGS. 1-9, the power threading and cutting device 10 of the present invention includes a sliding frame 12, a set of guide tubes 14, 16 and a support arm 18. Guide tubes 14, 16 are fastened to a vise structure 20 such as portable vise 22 so that they become an integral mechanical member of the vise 22. As illustrated in FIGS. 1 and 9, such fastening is achieved in the preferred embodiment shown through fasteners 24, washers 26 and nuts 28. It may be appreciated that any type of fasteners may be used to affix guide tubes 14, 16 to vise 22. Such fasteners may include bolts, screws, pins and the like with associated nuts, pins and the like to secure guide tubes 14, 16 to vise 22 as required.

As illustrated in FIGS. 1-9, sliding frame 12 freely and laterally slides through guide tubes 14, 16 and contains removable stop pins 30 that stop sliding frame 12 in a precise position and/or allow the removal of the sliding frame from the integral vise structure 20. Sliding frame 12 contains a frame guide tube 32 with an axis parallel to that of the vise's horizontal plane. The support arm 18 freely slides with respect to, and most preferably through, sliding frame guide tube 32. Sliding frame guide 32 includes removable stop pins 34 that may be positioned through sliding frame 12 and guide tube 32 to stop support arm 32 in a precise location. Alternatively, stop pins 34 may be removed from sliding frame guide 32 allowing the removal of support arm 18 from the sliding frame guide tube 32.

Vise 22 is positioned on legs 36 such that vise 22 is supported thereon. Legs 36 may be adjustable such that the height of vise 22 can be varied to accommodate users of various heights or various work environments requiring adjustable height of the vise and a work piece. Legs 36 are fixed to the bottom of vise 22 using a holding structure 38. One preferred embodiment of holding structure 38 includes apertures 40 and associated retaining elements, such as screws, bolts, pins or the like. In another preferred embodiment, apertures 40 may be internally threaded and accept a threaded connection on legs 36.

As can best be seen in FIGS. 1, 2 and 9, in the illustrated preferred embodiment, guide tubes 14, 16 are attached to the bottom of vise 22 through the use of fasteners 24, washers 26 and nuts 28. Legs 36 are positioned at the bottom of vise 22 into apertures 40 and secured therein. Such construction mounts vise 22 and associated guide tubes onto legs 36 providing the base structure onto which sliding frame 12 and support arm 18 may be positioned for use. Vise 22 includes a cradle 42 to accept the work piece for processing by the power threading and cutting device. Such a work piece is illustrated as pipe 44. In addition, to secure the work piece or pipe 44 to vice 22 and within cradle 42, securing members such as straps, clamps, cradles or other holding devices (not shown) may be included.

Now referring to FIGS. 10-17, the operation of the power threading and cutting device will be described. FIGS. 10-13 show the preferred embodiment with a portable power threader/cutter 46 in a home position. In the home position, support arm 18 is positioned as close as possible laterally to the vise and as distant as possible from the front of the vice. In this home position, the structure of the invention is completely cleared from the front of vise 22, allowing for normal use of the vise including positioning of the work piece such as pipe 44.

FIGS. 14-17 show the preferred embodiment with portable power threader/cutter 46 in a work position. In the work position, support arm 18 and sliding frame 32 are is positioned as close as possible laterally to the vise and as distant as possible from the front of the vice. In the work position, sliding frame 12 is located as far laterally from the work as the sliding frame 12 and stop pins 30 allow. Such movement limits of the sliding frame 12 can be adjusted for any particular power drive and work piece combination. In the work position, support arm 18 is extended as proximal as possible to the front of the vise, positioning it directly under vise 22 and such that the weight of power threader/cutter 46 is distributed to allow legs 36 in combination with holding structure 38 to support vise 22, sliding frame 12, guide tubes 14,16, support arm 18 and frame guide tubes 32. Stop pins 30 allow support arm 18 to be moved and stopped at a position which can be adjusted according to each particular user's preferences.

A preferred construction of sliding frame 12 is illustrated in FIG. 9. Preferred pipe sizes for construction of sliding frame 12, including guide tubes 14, 16, support arm 18 and frame guide tube 32, may be 1 NPS, SCH 40 and 1¼ NPS, SCH 40. Nominal Pipe Size (NPS) is a North American set of standard sizes for pipes used for high or low pressures and temperatures. Pipe size is specified with two non-dimensional numbers: a nominal pipe size (NPS) based on inches, and a schedule (Sched. or Sch.). “Schedule” refers to the thickness of a pipe wall and therefore how strong it is and how much pressure it can handle. It may be appreciated that many other pipe type and size combinations exist that would allow for similar construction that include an inner diameter that allows for a loose, sliding fit over standard 1¼ inch pipe and other sizes as determined by the application and cost of the power threading and cutting device. Preferably, the material composition would be such that would allow for easy cutting and welding. Most preferably, standard steel water pipe with a coating including a tough, corrosion-resistant finish may be used. Such finishes or coatings may include, without limitation, black vinyl coating. Variations of such type, finish and coating are also contemplated.

As shown in the preferred embodiments of FIGS. 1-17, sliding frame 12 is most preferably composed of two lengths of size 1 pipe welded parallel to frame guide tube 32. Guide tubes 14, 16 are constructed of 1¼ inch pipe and positioned to receive sliding frame 12 therein. Sliding frame 12 may be constructed of 1 inch pipe (such as 1 NPS, SCH 40 noted above). It is contemplated and preferred that sliding frame 12, guide tubes 14,16, support arm 18, frame guide tube 32, receiving tubes 32A, 32B and other components of the power threading and cutting device contain a corrosion-resistant and durable coating which may be placed inside the pipe, outside the pipe, or both inside and outside the pipe, depending on the environment in which the power threading and cutting device is used.

As shown in FIG. 9, the ends of each of the two parallel lengths of size 1 pipe of sliding frame 12 contain an aperture 31, preferably a hole drilled therein, to slidably-accept stop pin 30. A similar aperture 35 is placed at each end of support arm 18, to slidably-accept stop pins 34. As may be appreciated, stop pins 30 and 34 can be any metallic bolt, pin, or quick-connect type of pin product. Support arm 18 is preferably made of size 1 pipe.

Many methods of fabrication can be employed in the construction of guide tubes 14,16 and each of these guide tubes is made of the size 1¼ pipe and contains features that allow for mechanical connection to the vise stand. Shown in the drawings is one of the preferred embodiments, in which fasteners 24, illustrated as threaded studs, are welded to the guide tubes 14, 16.

These studs are then received by apertures or holes (not shown), which are drilled in a specific pattern, in vise 22. As may be appreciated, this hole pattern is parallel and at the same separation distance as the receiving tubes 32A, 32B of sliding frame 12 once they are fastened to the vise stand. Other methods attachment of guide tubes 14, 16 to vise 22 include clamping, hanging, welding, or any other form of mechanical connection. After being mechanically-fastened to the frame of vise 22, guide tubes 14,16 must be capable of slidably-accepting sliding frame 12 and receiving tubes 32A and 32B. Similarly, after welding or other mechanical attachment, frame guide tube 32 must slidably-accept support arm 18.

As shown in FIGS. 14-17, during operation, including threading or cutting, sliding frame 12 is slid laterally away from the work piece, illustrated as pipe 44, and support arm 18 is slid proximally to the front of the front of vise 22. Support arm 18 is then in a position to make contact with the frame of the power drive, illustrated as power threader/cutter 46, to support not only the reactionary torque generated during operation of power threader/cutter 46, but also the weight of the power threader/cutter during operation. This construction is sized so that its structure is sufficient to support relatively large loads in the vertical direction, and still slides in two horizontal directions. The first horizontal direction allows support arm 18 to clear the work area including the front of vise 22 and the pipe 44, as well as move power threader/cutter 46 into position at the front of pipe 44. The second horizontal direction allows sliding frame 12 to be retracted towards vise 22 for ease of storage and to increase portability, as well as to position and move power threader/cutter 46 into position for working on pipe 44.

Both sliding frame 12 and support arm 18 can be moved freely, rapidly, and in unison to support portable thread/cutter 46 for operation or moved out of the way to allow for freedom of movement of the portable thread/cutter 46 or other power drive unit. Portable power drive units including power threader/cutters such as power threader/cutter 46, provide the torque necessary to rapidly cut, thread or otherwise process up to 2″ diameter pipe. It is this type of operation of the power threading and cutting device of the present invention that becomes very successful and otherwise improved over previously used devices. It will be understood that the ease of use and portability of the power threading and cutting device of the present invention also provide significant improvements in threading, cutting or otherwise processing smaller work pieces, including pipe smaller the 1 inch in diameter. When properly setup, a time frame of approximately two seconds is required to correctly operate the adjustable power threading and cutting device of the present invention—even for the inexperienced user.

In summary, the power threading and cutting device of the present invention includes guide tubes 14, 16 which slidably accept sliding frame 12 including frame guide tube 32 and receiving tubes 32A and 32B. Sliding frame 12 includes frame guide tube 32 which slidably accepts support arm 18. These features, either singly or in combination, provide the unique support and movement to improve the operation of threading, cutting or otherwise processing work pieces at a work site. Such construction and operation, particularly the slidable movement in two horizontal planes either singly or in unison, allow for the precise and easy positioning and location of support arm 18 during the threading, cutting or processing of a work piece. Such construction provides for ease of assembly and dis-assembly simply and quickly. Sliding frame 12 can be received in guide tubes 14, 16 either from the left or from the right side accommodating either right or left handed users.

In transferring the reactionary torque of the power drive directly back through to vise 22 and holding structure 38, including legs 36, completes the mechanical loop back to pipe 44 being threaded. Any plurality of frames or structures may be devised to achieve this goal. To best control the reactionary torque of power threader/cutter 46, it is advantageous to restrict freedom of power threader/cutter 46 to directions lateral and longitudinal to the axis of pipe 44 being threaded or cut. Such constraint is achieved by the construction of the power threading and cutting device with improved support of the present invention. Sliding frame 12 allows lateral movement of the mechanical connection point to the axis of the work piece or pipe 44, while support arm 18 allows longitudinal movement of the connection point to the axis of the work piece, namely pipe 44, and the combination of all the members described and illustrated in FIGS. 1-17 constrains movement in the direction of the force generated in the frame of the power threading and cutting.

As Shown in FIGS. 10-12, the portable power drive, illustrated as power threader/cutter a convenient location to store the power drive when it is not in use. Since the mechanics of the invention support large loads in the vertical direction, heavy objects like the power drive itself may be hung from the extended members of the invention. A structural feature of the power threading and cutting device disclosed is the multiple axis and multiple plane sliding of support arm 18. This allows the user to quickly clear the workspace and the swing area of the power drive to safely and efficiently operate the device. Another unique structural feature of the invention is the orientation and separation of guide tubes 14, 16. The distance of separation of guide tubes 14, 16 directly influences the stiffness of support arm 18 in the vertical direction. Noteworthy is the welding process used to attach the size 1 receiving tubes 32A, 32B to the sliding frame 12. Such mechanical connection must be strong enough to resist the rather large torque produced about the axes of these tubes during the threading and cutting process. For safe operation, a desired threaded connection to be able to resist the torque created by power threading/cutter 46 during use.

It is contemplated that sliding frame 12 could be integrated with guide tubes 14, 16 and could simply become part of the vice frame itself, allowing for insertion and subsequent two axis movement of sliding frame 12 as described above. This embodiment would function substantially similarly to the embodiments described above.

It is also contemplated that the advantages described herein may be retained with any method of mechanically placing guide tubes 14, 16 at the correct location relative to the work piece or pipe 44. This could be achieved with a hinged connection to the vise with an additional locking feature. These advantages could also be retained through any method of hanging, attaching, or mechanically communicating with the vise in such a way that would mechanically maintain guide tubes 14, 16 in the desired location. In addition, support arm 18 may not have to be slidably-accepted into the guide tube 32. Support arm 18 could be integrated into the guide tube 32 through a pivotal or rotatable connection. This would allow for quick clearing of the workspace in a swinging fashion rather than a sliding fashion.

In addition to the specific examples above, it is contemplated that any combination of mechanical joints or connections could be employed to locate support arm 18 in the preferred position relative to the frame of the power drive and still retain the advantages of quick workspace clearance and storability.

It will be understood that the invention contains geometry that can act as a carrying handle for the vise stand. Similarly, the structure allows for convenient hanging and storage of the vise stand. The invention also may be used with any tool that produces a reactionary torque about the work. Other tools may include, but are not limited to, threaders, knurlers, cutters, groovers, expanders, contracters, deburing tools, chamfer-cutting tools, and the like. The invention can be used as a location from which to hang or store tools or devices such as oilers, wrenches, benders, and dies and the like.

Reference throughout this specification to “one embodiment,” “an embodiment,” “a preferred embodiment” or similar language means that a particular feature, structure, or characteristic described in connection with the embodiment is included in at least one embodiment of the present invention. Thus, appearances of the phrases “in one embodiment,” “in an embodiment,” “in a preferred embodiment,” and similar language throughout this specification may, but do not necessarily, all refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

While the present invention has been described in connection with certain exemplary or specific embodiments, it is to be understood that the invention is not limited to the disclosed embodiments, but, on the contrary, is intended to cover various modifications, alternatives, modifications and equivalent arrangements as will be apparent to those skilled in the art. Any such changes, modifications, alternatives, modifications, equivalents and the like may be made without departing from the spirit and scope of the invention.

What is claimed is:

1. An adjustable support for power threading and cutting devices comprising a stand adapted for holding a work piece, a support member, and an adjustable bracket mounted to the stand and configured to receive the support member whereby the support member is free to move longitudinally and laterally with respect to the work piece so that the support member can be positioned either distal or proximal to a front end of the stand.

2. The adjustable support of claim 1 wherein the support member is a support arm which is secured to the elevated stand.

3. The adjustable support of claim 2 wherein the support arm is slidably received along an axis parallel to the work piece.

4. The adjustable support of claim 2 wherein the support arm is slidably received along at least two axes parallel to the work piece.

5. The adjustable support of claim 2 wherein the support arm is slidably received along an axis parallel to the work piece by a receiving member positioned outward from the elevated stand.

6. The adjustable support of claim 5 including a vise attached to the elevated stand having a receiving cradle for receiving the work piece and wherein the support arm is slidably received along an axis parallel to the work piece.

7. The adjustable support of claim 6 wherein the receiving cradle is a tray having a length which is dimensioned for receiving and holding the work piece.

8. The adjustable support of claim 5 wherein the receiving member is a hollow frame member positioned outward from the elevated stand.

9. The adjustable support of claim 8 wherein the support arm is slidably received by the frame member fastened to the tray and the support arm is free to move longitudinally and laterally with respect to the work piece while the work piece is held in position upon the tray.

10. A power threading and cutting device comprising a powered element to engage a work piece, an elevated stand adapted for holding the work piece, a support member and an adjustable bracket mounted to the stand and configured to receive the support member, the support member being free to move longitudinally and laterally with respect to the work piece so that the support member can be positioned either distal or proximal to a front end of the elevated stand.

11. The power threading and cutting device of claim 10 wherein the support arm resists the torque forces placed upon the drive when the power threading and cutting device is engaged with the work piece.

12. The power threading and cutting device of claim 10 wherein the support arm is secured to the elevated stand.

13. The power threading and cutting device of claim 10 wherein the support arm is slidably received along an axis parallel to the work piece.

14. The power threading and cutting device of claim 10 wherein the support arm is slidably received along at least two axes parallel to the work piece.

15. The power threading and cutting device of claim 10 wherein the support arm is slidably received along an axis parallel to the work piece by a receiving member positioned outward from the elevated stand.

16. The power threading and cutting device of claim 15 wherein the work piece is a pipe and including a vise attached to the elevated stand having a receiving cradle for receiving the pipe and wherein the support arm is slidably received along an axis parallel to the pipe.

17. The power threading and cutting device of claim 16 wherein the receiving cradle is a tray having a length which is dimensioned for receiving and holding the pipe.

18. The power threading and cutting device of claim 15 wherein the receiving member is a hollow frame member positioned outward from the elevated stand.

19. The power threading and cutting device of claim 18 wherein the support arm is slidably received by the frame member fastened to the tray and the support arm is free to move longitudinally and laterally with respect to the work piece while the work piece is held in position upon the tray.

20. A machine support apparatus for use with a portable power drive device comprising an elevated stand for holding a length of pipe, a support member for supporting the portable power drive device, an adjustable bracket mounted to the stand for receiving the support member, the support member and the portable power drive being movable longitudinally and laterally with respect to the pipe so that the portable power drive can be positioned with respect to the front of the stand for engagement with the pipe.

21. The machine support apparatus of claim 20 wherein the support arm resists the torque forces placed upon the drive when the portable power drive device is engaged with the pipe.

22. The machine support apparatus of claim 21 wherein the support arm resists the torque forces placed upon the drive when the portable power drive device is engaged with and threading the pipe.
